(19) United States
(12) Patent Application Publication
(10) Pub. No.: US 2026/0111538 A1
(43) Pub. Date: Apr. 23, 2026

(54) DETECTION OF ABNORMAL ACCESS BEHAVIOR BASED ON MACHINE LEARNING

(71) Applicant: TP-Link Systems Inc., IRVINE, CA (US)

(72) Inventors: Wenhao ZHU, Shenzhen (CN); Han WANG, Shenzhen (CN); Guocheng WU, Shenzhen (CN)

(73) Assignee: TP-Link Systems Inc., IRVINE, CA (US)

(21) Appl. No.: 18/921,703

(22) Filed: Oct. 21, 2024

(51) Int. Cl. G06F 21/55; G06F 17/40

(52) U.S. Cl. CPC G06F 21/55; G06F 17/40

(57) ABSTRACT

Disclosed are a method, a device and a computer program product for detecting abnormal access behavior based on machine learning. The method includes: obtaining log files stored with access records to create a data set based on the log files; processing the data set as a set of access behavior sequences; clustering feature vectors of a portion of access behavior sequences in the set of access behavior sequences based on a clustering algorithm in the machine learning and using a centroid of a cluster as a basis for dividing the feature vectors to construct an access behavior recognition model; and automatically recognizing whether an access behavior is the abnormal access behavior through the access behavior recognition model.

### TECHNICAL FIELD

The present disclosure relates to a field of machine learning, and in particular, to methods, devices and computer program products for detection of abnormal access behavior based on machine learning.

### BACKGROUND

As a core of digital infrastructure, data security of data center is essential whether the data center is an internal data center of an enterprise or a hosted data center. As an important part of data security, Data Access Behavior Monitoring can promptly discover and respond to potential security threats or abnormal access behavior by monitoring, analyzing and auditing the data access behavior of users or systems in the data center in real time.

However, with the explosive growth of business, the rapidly increasing access entities (users or systems that need to access data), complex business access scenarios and massive access activities, data access behavior monitoring is facing increasing challenges. Taking Amazon Web Services (AWS) Simple Storage Service (S3) as an example, S3 logs record various users' operations on S3 buckets, such as reading, writing, deleting, updating configuration, etc. Based on these logs, it is necessary to identify abnormal access behavior, that is, operations that are obviously inconsistent with the normal pattern. Abnormal access behavior may include abnormal access frequency, unauthorized access, configuration modification of S3, etc., In order to find this abnormal access behavior, it is necessary to check the logs, but most of these methods rely on manual work, which has the characteristics of high cost and low degree of automation, and cannot detect the abnormal access behavior to the S3 bucket in a timely, fast and accurate manner.

Since the concept of machine learning was put forward, it has developed rapidly and attracted the attention of many scholars. Machine learning uses supervised or unsupervised feature learning to achieve the goal of completing a specific task. However, the previous methods of abnormal access behavior recognition are limited by the formulation of recognition rules, and cannot cope with complex access scenarios. Also, there is a strong correlation between the abnormal access behavior recognition method and the accessed system, and there will be a big difference in the recognition accuracy between different systems.

In view of the above problems, this patent proposes a method for recognizing abnormal access behavior based on machine learning.

### SUMMARY

The present disclosure provides techniques of detecting abnormal access behavior based on machine learning. Based on access records, the recognition model of general access behavior is obtained through machine learning training, and the access that cannot be judged by the model as general behavior is regarded as abnormal access behavior.

In accordance with one embodiment of the present disclosure, there is provided a method for detecting abnormal access behavior based on machine learning. The method comprises: obtaining log files stored with access records to create a data set based on the log files; processing the data set as a set of access behavior sequences; clustering feature vectors of a portion of access behavior sequences in the set of access behavior sequences based on a clustering algorithm in the machine learning and using a centroid of a cluster as a basis for dividing the feature vectors to construct an access behavior recognition model; and automatically recognizing whether an access behavior is the abnormal access behavior through the access behavior recognition model.

In accordance with another embodiment of the present disclosure, there is provided a device for detecting abnormal access behavior based on machine learning. The device may comprise one or more processors; a memory coupled to the one or more processors; and a set of computer program instructions stored in the memory. When executed by the one or more processors, the set of computer program instructions may perform the following actions: obtaining log files stored with access records to create a data set based on the log files; processing the data set as a set of access behavior sequences; clustering feature vectors of a portion of access behavior sequences in the set of access behavior sequences based on a clustering algorithm in machine learning and using a centroid of a cluster as a basis for dividing the feature vectors to construct an access behavior recognition model; and automatically recognizing whether an access behavior is the abnormal access behavior through the access behavior recognition model.

In accordance with a further embodiment of the present disclosure, there is provided a computer program product for detecting abnormal access behavior based on machine learning. The computer program product may comprise a non-transitory computer readable storage medium having program instructions embodied therewith. The program instructions are executable by one or more processor to cause the one or more processor to: obtain log files stored with access records to create a data set based on the log files; process the data set as a set of access behavior sequences; cluster feature vectors of a portion of access behavior sequences in the set of access behavior sequences based on a clustering algorithm in machine learning and use a centroid of a cluster as a basis for dividing the feature vectors to construct an access behavior recognition model; and automatically recognize whether an access behavior is the abnormal access behavior through the access behavior recognition model.

In accordance with the embodiments of the present disclosure, through using a part of the data to initialize the clustering, and then using the centroid as the basis for partitioning each feature vector, the speed of model training is greatly accelerated, and the accuracy of the model is not reduced. The method of the invention belongs to an unsupervised method. Aiming at the complex situation where a large number of different entities access in the storage service system, the information can be independently mined, thereby avoiding the disadvantages of the supervised method requiring labels, greatly reducing the labor cost, reducing the requirements of manual intervention and subjective judgment, and improving the automation benefit.

### BRIEF DESCRIPTION OF THE DRAWINGS

For the purpose that the present disclosure may be understood in detail, a more particular description of the present disclosure, briefly summarized above, may be made by reference to embodiments, some of which are illustrated in the accompanying drawings, in which the same reference generally refers to the same components in the embodiments of the present disclosure.

FIG. 1 illustrates an exemplary method 100 for detecting abnormal access behavior based on machine learning in accordance with an embodiment of the present disclosure;

FIG. 2 shows a schematic diagram 200 of a hierarchical clustering algorithm used in step S3 in FIG. 1 in accordance with an embodiment of the present disclosure;

FIG. 3 shows a schematic diagram 300 of obtaining clusters using centroids in step S3 in FIG. 1 in accordance with an embodiment of the present disclosure;

FIG. 4 illustrates another exemplary method 400 for detecting abnormal access behavior based on machine learning; and

FIG. 5 shows a schematic block diagram of a device 500 for detecting abnormal access behavior based on machine learning in accordance with an embodiment of the present disclosure.

One skilled in the art will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

The following detailed description refers to the accompanying drawings. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “obtaining”, “processing”, “calculating”, “clustering”, “recognizing”, “comparing”, “adjusting”, “generating”, “analyzing”, “sorting”, “traversing” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

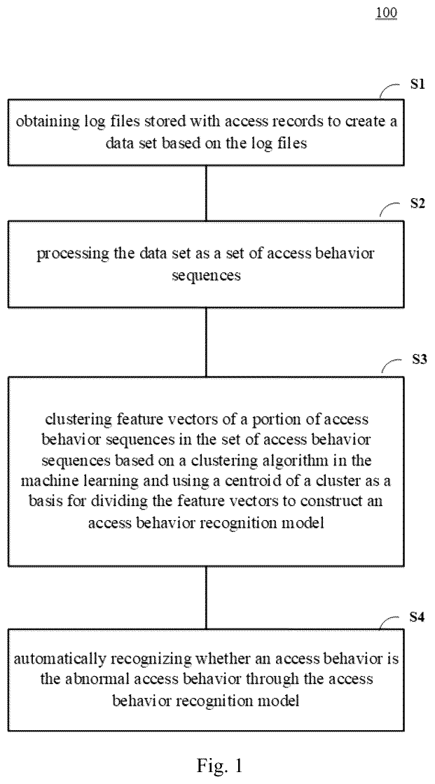

FIG. 1 illustrates an exemplary method 100 for detecting abnormal access behavior based on machine learning in accordance with an embodiment of the present disclosure. As shown in FIG. 1, method 100 may include steps S1˜S4.

The method 100, at step S1, includes obtaining log files stored with access records to create a data set based on the log files. In some embodiments, log files are files used to record a user's access behavior in a storage service system, such as Google Drive, Dropbox, Microsoft OneDrive, Apple iCloud, Amazon Drive, Box, and so on. In some embodiments, the log files may include log files in Simple Storage Service (S3) of Amazon Web Services (AWS). In an embodiment, the device is applicable to all data centers, including internal data centers and hosted data centers.

Let's take Amazon Web Service (AWS) as an example, creating the data set may comprise: with AWS CloudTrail log files, logging the activity of the AWS service, wherein the AWS CloudTrail log files are stored in the S3 bucket as compressed files and in different directories depending on the zone; obtaining the AWS CloudTrail log files

$$LF = {\sum }_{i = 1}^{n} l {f}_{{R}_{i}} ,$$

i=1, 2, . . . , n}, where Rᵢ represents the i-th AWS region, lf_{R}_{ᵢ} refers to the log of the i-th AWS region, and n represents a number of AWS regions; and extracting log files with a value of s3.amazonaws.com through an eventSource field in the AWS CloudTrail log files to create the dataset L=LF_{eventSource=s3.amazonaws.com}.

The method 100, at step S2, includes processing the data set as a set of access behavior sequences. In some embodiments, processing the data set as a set of access behavior sequences comprising: extracting information of specified fields indicating an access behavior of a user from the data set to generate the set of access behavior sequences based on the extracted information.

In some embodiments, the specified fields may include username field, eventName field, eventTime field, userIP field and other fields indicating an access behavior of a user.

In some embodiments, generating the set of access behavior sequences may comprise: extracting username, eventName and eventTime information from the data set L to form a triple set s=(username, eventName, eventTime) to obtain all triple sets S={sᵢ, i=1, 2, . . . , n}, where n represents the size of the data set L; unifying eventTime in sᵢ to UTC+0 time, and sorting the triple set S according to a temporal order to obtain a temporal ordered set S_{sorted}; setting the size of a time sliding window to T, where tₛ_{ᵢ} is the value of eventTime in sᵢ, setting the initial value of t_{begin} to the value of tₛ_{₀}, and initializing an empty set Sₒₚₛ as the set of access behavior sequences; obtaining a subset S_{sub}={sⱼ|tₛ_{ⱼ}∈[t_{begin}, t_{begin}+T], j=1, 2 . . . , n} of the temporal ordered set S_{sorted} constructed by all s in the temporal ordered set S_{sorted} in the time range [t_{begin} t_{begin}+T]; making all uₛ_{ⱼ} of the subset S_{sub} into a set, where uₛ_{ⱼ} represents the value of username in sⱼ, and deduplicating to get a set U={uₖ, k=1, 2, . . . , m}, where m is the number of u after deduplication; traversing the temporal ordered set S_{sub}, and putting aₛ_{ⱼ} of sⱼ with the same uₛ_{ⱼ} in the same array, to obtain a set opsᵢ=[a₁, a₂, . . . , aₚ], i=1, 2 . . . , m, where as, is the value of eventName in sⱼ; adding the obtained set opsᵢ into the empty set Sₒₚₛ; and updating t_{begin}=t_{begin}+T, and generating the set of access behavior sequences Sₒₚₛ in response to the value of t_{begin} is bigger than tₛ_{ₙ}.

In some embodiments, with regard to a time partition method, in addition to the above method of dividing the time by using the sliding window, other time partition methods that can distinguish the two access behaviors of the user can also be used.

The method 100, at step S3, includes clustering feature vectors of a portion of access behavior sequences in the set of access behavior sequences based on a clustering algorithm in the machine learning and using a centroid of a cluster as a basis for dividing the feature vectors to construct an access behavior recognition model.

In some embodiments, a feature vector for each access behavior sequence in the set of access behavior sequences may be calculated by: obtaining an event set A={a₁, a₂, . . . , a_{q}} from the set of access behavior sequences Sₒₚₛ, where A represents all eventName that have occurred in the set of access behavior sequences Sₒₚₛ, and q represents the total number of classes; traversing the access behavior sequences in Sₒₚₛ, and counting the number of occurrences Cₒₚₛ_{ᵢ}= {cᵢ₁, cᵢ₂, . . . , c_{iq}}, i=1, 2 . . . , m of each aᵢ corresponding to each access behavior sequence; and calculating the feature vector vᵢ=W·Cₒₚₛ_{ᵢ}, i=1, 2 . . . , m, where vᵢ represents the feature vector of an access behavior sequence opsᵢ, and W represents a weight vector.

In some embodiments, the weight vector W may be calculated by: calculating by Cₒₚₛ_{ᵢ} to get that aᵢ occurs in cₐ_{ᵢ} number of the access behavior sequence opsᵢ, and calculating its corresponding weight

$${w}_{i} = ln \frac{m}{{c}_{{a}_{i}} + ε}$$

to obtain the weight vector W={w₁, w₂, . . . , w_{q}}, where ε is the bias. For example, the value range of the bias ε is [0, 1].

In some embodiments, other algorithms can also be used to obtain the weight vector. For example, by manual setting, or other algorithms by adding or deleting the algorithm used in the present invention.

In some embodiments, the machine learning nay be based on an unsupervised learning algorithm.

In some embodiments, constructing the access behavior recognition model may comprise: clustering the feature vectors of the portion of access behavior sequences using the clustering algorithm to obtain an initial clustering model containing a plurality of clusters; and clustering feature vectors of other access behavior sequences in the set of access behavior sequences into a corresponding cluster of the plurality of clusters based on a centroid of each cluster of the plurality of clusters to obtain the access behavior recognition model.

In some embodiments, constructing the access behavior recognition model may further comprise: calculating the similarity between the feature vectors of the portion of access behavior sequences to cluster the feature vectors of the portion of access behavior sequences to obtain the initial clustering model containing the plurality of clusters; for the each cluster, obtaining the centroid of the each cluster by calculating an average value of feature vectors in the each cluster; obtaining a centroid corresponding to a minimum value by calculating the minimum value of similarity between the feature vectors of other access behavior sequences and the centroid of the each cluster; comparing the centroid corresponding to the minimum value with a clustering threshold; and adjusting the initial clustering model based on a comparison result.

In some embodiments, calculating the similarity between the feature vectors of the portion of access behavior sequences may further comprise: calculating the similarity between the feature vectors of the portion of access behavior sequences to cluster the feature vectors of the portion of access behavior sequences by the following formula:

$$Similarity ( {v}_{i} , {v}_{j} ) = 1 - \frac{{v}_{i} \cdot {v}_{j}}{‖ {v}_{i} ‖ \cdot ‖ {v}_{j} ‖}$$

where ∥⋅∥ is a l₂ norm, vᵢ representing the feature vector of the i-th access behavior sequence, vⱼ representing the feature vector of the j-th access behavior sequence, where i,j=1, 2, . . . , m, and m is the total number of access behavior sequences; for the each cluster, obtaining a centroid repᵢ, i=1, 2, . . . , n_{cluster} of the each cluster by calculating an average value of feature vectors in the each cluster, where n_{cluster} representing a number of clusters obtained based on the clustering algorithm; obtaining a centroid repₘᵢₙ corresponding to a minimum value by calculating the minimum value min (Similarity (vᵢ,repⱼ)) of similarity between the other feature vectors and the centroid of the each cluster; comparing the centroid repₘᵢₙ corresponding to the minimum value with a clustering threshold; and adjusting the initial clustering model based on a comparison result.

In some embodiments, adjusting the initial clustering model based on the comparison result may comprise: in response to the centroid corresponding to the minimum value is greater than or equal to the clustering threshold, the number of clusters n_{cluster}=n_{cluster}+1, and repₙ_{_{cluster}}=vᵢ, where repₙ_{_{cluster}} represents the centroid of the n_{cluster}-th cluster; and in response to the centroid corresponding to the minimum value is smaller than the clustering threshold, adding the corresponding feature vector among the feature vectors of other access behavior sequences into the corresponding cluster, and updating the centroid corresponding to the minimum value by the following formula:

$${rep}_{min} = {rep}_{min} + \frac{{v}_{i} - {rep}_{min}}{\vert Cluster ( {rep}_{min} ) \vert}$$

wherein repₘᵢₙ represents a centroid corresponding to the minimum value, vᵢ represents a feature vector among the feature vectors of other access behavior sequences, and Cluster(repₘᵢₙ) represents the obtained cluster corresponding to repₘᵢₙ.

In some embodiments, the number of clusters in the access behavior recognition model may be regulated by the clustering threshold.

The method 100, at step S4, includes automatically recognizing whether an access behavior is the abnormal access behavior through the access behavior recognition model.

In some embodiments, recognizing whether an access behavior is the abnormal access behavior may comprise: for the current time T_{now}, obtaining an access log file within a time period [T_{now}-T_{begin}>T_{now}-T_{end}], where T_{begin}>T_{end}>0; generating a set of access behavior sequences corresponding to the access log file in the time period according to step S2; calculating a feature vector for each access behavior sequence in the set of access behavior sequences corresponding to the access log file according to step S3; calculating a minimum value of similarity between the feature vector and all centroids of the access behavior recognition model to determine a cluster to which the feature vector belongs and the corresponding centroid; calculating a distance between the feature vector and the corresponding centroid based on a distance algorithm to obtain a minimum distance value; and comparing the minimum distance value to a predefined threshold, wherein: in response to the minimum distance value is greater than the predefined threshold, the access behavior recognition model recognizes the access behavior corresponding to the feature vector as the abnormal access behavior; and in response to the minimum distance value is less than or equal to the predefined threshold, the access behavior recognition model recognizes the access behavior corresponding to the feature vector as a normal access behavior.

For example, in the present invention, the value range of the predefined threshold in the invention is [0.2, 0.3]. It should be emphasized that both the predefined threshold and the previously mentioned clustering threshold will be affected by the feature extraction algorithm. Because the method of the invention uses cosine distance, the predefined threshold is basically in the interval of [0, 1], and then according to the experiment of the actual scene, the value range is further limited to [0.2, 0.3] and [0.2, 0.4]. If other feature extraction methods are used in the implementation of the invention, the value range of the predefined threshold will change. In addition, the clustering threshold and the predefined threshold mentioned in the method of the invention will simultaneously affect the final output result of the access behavior identification model according to the embodiment of the invention.

Traditional abnormal access behavior recognition methods use a clustering algorithm to cluster all data, and recognize abnormal behaviors based on the analysis results of the clustering algorithm. However, for large data volumes, the performance of traditional abnormal access behavior recognition methods may be insufficient, resulting in poor results. According to the method 100 for detecting abnormal access behavior based on machine learning in accordance with an embodiment of the present disclosure, through using a part of the data to initialize the clustering to obtain centroids, and then using the centroid as the basis for partitioning each feature vector, instead of directly looking for the centroid on all data. This method is suitable for situations with large and complex data volume, and can greatly speed up the speed of model training without reducing the accuracy of the model.

In addition, machine learning uses supervised or unsupervised feature learning to achieve the goal of completing specific tasks. The method 100 according to embodiments of the present disclosure uses an improved hierarchical clustering algorithm to achieve unsupervised machine learning. Aiming at the complex situation where a large number of different entities access in the storage service system, the information can be independently mined, thereby avoiding the disadvantages of the supervised method requiring labels, greatly reducing the labor cost, reducing the requirements of manual intervention and subjective judgment, and improving the automation benefit.

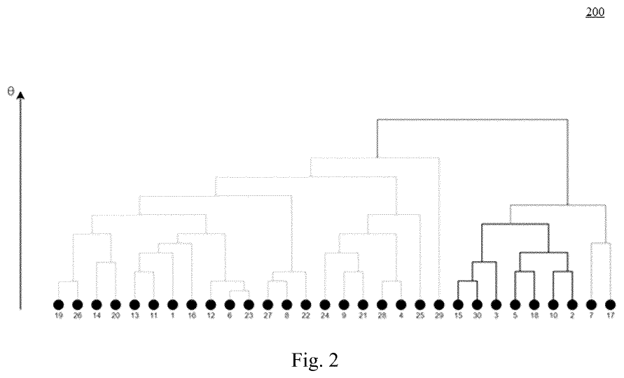

FIG. 2 shows a schematic diagram 200 of a hierarchical clustering algorithm used in step S3 in FIG. 1 in accordance with an embodiment of the present disclosure.

The clustering algorithm adopted by the invention uses high-dimensional eigenvalues, and cannot give a vivid image description, so here points in the two-dimensional plane represent the actual high-latitude data points, and each point corresponds to a number. Since the initialization stage of the clustering model uses a bottom-up hierarchical clustering algorithm, as shown in the FIG. 2, the distance between points will be calculated by the distance algorithm, and then the points that are closest and meet the clustering threshold will be divided into a cluster, for example, the two points at 19 and 26 in FIG. 2 are divided together. The new cluster will be regarded as a whole, and further matches with other clusters or unmatched points. According to the different clustering threshold θ, different numbers of clusters will be obtained. As shown in the θ axis in FIG. 2, the value of clustering threshold θ will determine the stage of clustering.

In addition, the value of the clustering threshold will affect the number of final clusters. For example, in the invention, the value range of the clustering threshold is [0.2, 0.4]. The smaller the clustering threshold value is, the more detailed the cluster division is and the more the number of clusters is, but this is not strongly related to the final accuracy and needs to be combined with the actual business situation.

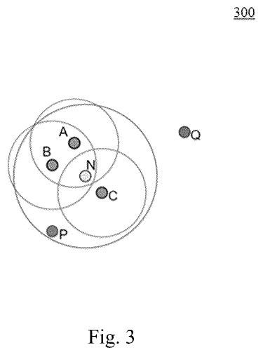

FIG. 3 shows a schematic diagram 300 of obtaining clusters using centroids in step S3 in FIG. 1 in accordance with an embodiment of the present disclosure.

Similarly, it can be described based on two-dimensional feature vector. As shown in FIG. 3, points A, B and C are the points in clusters. The centroid N can be calculated from these three points, wherein the centroid is a simple coordinate point, not necessarily a point in the data. If drawing a circle with N as the center and the threshold δ as the radius, it can get a blue circle range as shown in FIG. 3. It can be seen that point Q is not within the range of the circle, that is, it is larger than the threshold δ and cannot be classified into the cluster, while point P is within the range of the circle, it can be classified into the cluster. In addition, due to the addition of P, the position of the centroid needs to be recalculated.

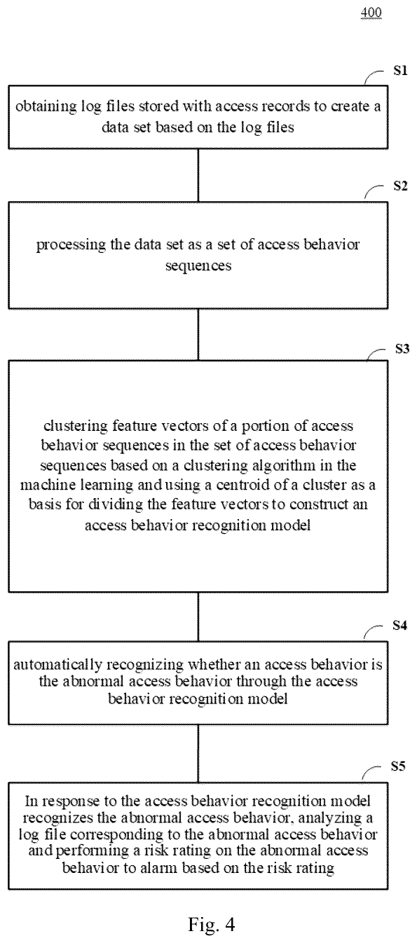

FIG. 4 illustrates another exemplary method 400 for detecting abnormal access behavior based on machine learning. The steps S1-S4 in FIG. 4 can refer to the steps S1-S4 in FIG. 1, and details are omitted herein for conciseness.

The method 400, at step S5, in response to the access behavior recognition model recognizes the abnormal access behavior, analyzing a log file corresponding to the abnormal access behavior and performing a risk rating on the abnormal access behavior to alarm based on the risk rating.

In some embodiments, performing a risk rating on the abnormal access behavior to alarm based on the risk rating may comprise: extracting an event and a corresponding resource from the log file corresponding to the abnormal access behavior, wherein the event is divided into a high-level event, a medium-level event, and a low-level event, and the resource is divided into a risk resource and a safe resource; wherein in response to the extracted event includes the high-level event and the corresponding resource is the risk resource, the abnormal access behavior is defined as a high-risk behavior; in response to the extracted event includes the high-level event and the corresponding resource is the safe resource, or the extracted event includes the medium-level event and the corresponding resource is the risk resource, the abnormal access behavior is defined as a medium-risk behavior, and in response to the extracted event includes the medium-level event and the corresponding resource is the safe resource, or the extracted event includes the low-level event, the abnormal access behavior is defined as a low-risk behavior.

For example, according to actual business scenarios, a risk level is determined through impact assessment, that is, the impact of an abnormal access behavior, such as whether it may lead to the abuse, leakage, loss, etc. of user data.

A simplified example is as follows:
E_{high}: DeleteBucket
E_{medium}: GetObject
Rᵣᵢₛₖ: User data in S3 bucket

The abnormal behavior of calling DeleteBucket on the user data of the S3 bucket, which is considered as a high-risk behavior because it may involve a large-scale loss of user data. The abnormal behavior of calling GetObject on the user data of S3 bucket, which is considered as a medium-risk behavior because it may involve an abnormal read of a certain user data. The abnormal behavior of calling GetObject on non-user data of the S3 bucket, which is considered as low-risk behavior.

According to the method 400 for detecting abnormal access behavior based on machine learning in accordance with an embodiment of the present disclosure, it can automatically recognize the abnormal access behavior of users, analyze the resources involved in the abnormal access behavior, and timely alarm the abnormal access behavior, so as to ensure the security and privacy protection of data.

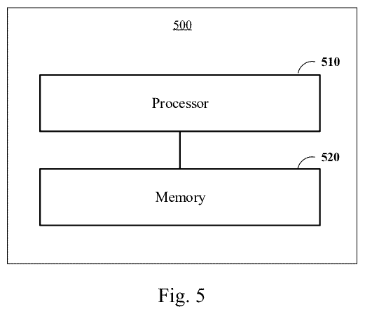

FIG. 5 shows a schematic block diagram of a device 500 for detecting abnormal access behavior based on machine learning in accordance with an embodiment of the present disclosure. The device 500 for detecting abnormal access behavior based on machine learning comprises one or more processors 510 and a memory 520 coupled to at least one of the processors 510. A set of computer program instructions are stored in the memory 520. When executed by the one or more processors 510, the set of computer program instructions may perform actions of: obtaining log files stored with access records to create a data set based on the log files; processing the data set as a set of access behavior sequences; clustering feature vectors of a portion of access behavior sequences in the set of access behavior sequences based on a clustering algorithm in machine learning and using a centroid of a cluster as a basis for dividing the feature vectors to construct an access behavior recognition model; and automatically recognizing whether an access behavior is the abnormal access behavior through the access behavior recognition model.

In an embodiment, when executed by the one or more processors, the set of computer program instructions further perform actions of: clustering the feature vectors of the portion of access behavior sequences using the clustering algorithm to obtain an initial clustering model containing a plurality of clusters; and clustering feature vectors of other access behavior sequences in the set of access behavior sequences into a corresponding cluster of the plurality of clusters based on a centroid of each cluster of the plurality of clusters to obtain the access behavior recognition model.

In an embodiment, when executed by the one or more processors, the set of computer program instructions further perform actions of: calculating the similarity between the feature vectors of the portion of access behavior sequences to cluster the feature vectors of the portion of access behavior sequences to obtain the initial clustering model containing the plurality of clusters; for the each cluster, obtaining the centroid of the each cluster by calculating an average value of feature vectors in the each cluster; obtaining a centroid corresponding to a minimum value by calculating the minimum value of similarity between the feature vectors of other access behavior sequences and the centroid of the each cluster; comparing the centroid corresponding to the minimum value with a clustering threshold; and adjusting the initial clustering model based on a comparison result.

In an embodiment, when executed by the one or more processors, the set of computer program instructions further perform action of: calculating the similarity between the feature vectors of the portion of access behavior sequences to cluster the feature vectors of the portion of access behavior sequences by the following formula:

$$Similarity ( {v}_{i} , {v}_{j} ) = 1 - \frac{{v}_{i} \cdot {v}_{j}}{‖ {v}_{i} ‖ \cdot ‖ {v}_{j} ‖}$$

where ∥⋅∥ is a l₂ norm, vᵢ representing the feature vector of the i-th access behavior sequence, vⱼ representing the feature vector of the j-th access behavior sequence, where i,j=1, 2, . . . , m, and m is the total number of access behavior sequences.

In an embodiment, when executed by the one or more processors, the set of computer program instructions further perform actions of: in response to the centroid corresponding to the minimum value is greater than or equal to the clustering threshold, the number of clusters n_{cluster}=n_{cluster}+1, and repₙ_{_{cluster}}=vᵢ, where repₙ_{_{cluster}} represents the centroid of the N_{cluster}-th cluster; and in response to the centroid corresponding to the minimum value is smaller than the clustering threshold, adding the corresponding feature vector among the feature vectors of other access behavior sequences into the corresponding cluster, and updating the centroid corresponding to the minimum value by the following formula:

$${rep}_{min} = {rep}_{min} + \frac{{v}_{i} - {rep}_{min}}{\vert Cluster ( {rep}_{min} ) \vert}$$

wherein repₘᵢₙ represents a centroid corresponding to the minimum value, vᵢ represents a feature vector among the feature vectors of other access behavior sequences, and Cluster(repₘᵢₙ) represents the obtained cluster corresponding to repₘᵢₙ.

In an embodiment, the number of clusters in the access behavior recognition model is regulated by the clustering threshold.

In an embodiment, when executed by the one or more processors, the set of computer program instructions further perform actions of: for a current time, obtaining an access log file within a time period before and after the current time; generating a set of access behavior sequences corresponding to the access log file in the time period; calculating a feature vector for each access behavior sequence in the set of access behavior sequences corresponding to the access log file; calculating a minimum value of similarity between the feature vector and all centroids of the access behavior recognition model to determine a cluster to which the feature vector belongs and the corresponding centroid; calculating a distance between the feature vector and the corresponding centroid based on a distance algorithm to obtain a minimum distance value; and comparing the minimum distance value to a predefined threshold, wherein: in response to the minimum distance value is greater than the predefined threshold, the access behavior recognition model recognizes the access behavior corresponding to the feature vector as the abnormal access behavior; and in response to the minimum distance value is less than or equal to the predefined threshold, the access behavior recognition model recognizes the access behavior corresponding to the feature vector as a normal access behavior.

In an embodiment, when executed by the one or more processors, the set of computer program instructions further perform actions of: in response to the access behavior recognition model recognizes the abnormal access behavior, analyzing a log file corresponding to the abnormal access behavior and performing a risk rating on the abnormal access behavior to alarm based on the risk rating.

In an embodiment, when executed by the one or more processors, the set of computer program instructions further perform actions of: extracting an event and a corresponding resource from the log file corresponding to the abnormal access behavior, wherein the event is divided into a high-level event, a medium-level event, and a low-level event, and the resource is divided into a risk resource and a safe resource; wherein in response to the extracted event includes the high-level event and the corresponding resource is the risk resource, the abnormal access behavior is defined as a high-risk behavior; in response to the extracted event includes the high-level event and the corresponding resource is the safe resource, or the extracted event includes the medium-level event and the corresponding resource is the risk resource, the abnormal access behavior is defined as a medium-risk behavior, and in response to the extracted event includes the medium-level event and the corresponding resource is the safe resource, or the extracted event includes the low-level event, the abnormal access behavior is defined as a low-risk behavior.

In an embodiment, when executed by the one or more processors, the set of computer program instructions further perform actions of: extracting information of specified fields indicating an access behavior of a user from the data set to generate the set of access behavior sequences based on the extracted information.

In an embodiment, the device is applicable to all data centers, including internal data centers and hosted data centers.

In an embodiment, the log files may include log files in Simple Storage Service (S3) of Amazon Web Services (AWS).

In an embodiment, when executed by the one or more processors, the set of computer program instructions further perform actions of: obtaining log files in a plurality of AWS regions; and extracting log files with a value of s3.amazonaws.com through an eventSource field in the AWS CloudTrail log files to create the dataset L.

In an embodiment, the information of specified fields may include username, eventName and eventTime information.

In an embodiment, when executed by the one or more processors, the set of computer program instructions further perform actions of: extracting username, eventName and eventTime information from the data set L to form a triple set s=(username, eventName, eventTime) to obtain all triple sets S={sᵢ, i=1, 2, . . . , n}, where n represents the size of the data set L; sorting the triple set S according to a temporal order to obtain a temporal ordered set S_{sorted}; setting the size of a time sliding window to T, where tₛ_{ᵢ} is the value of eventTime in sᵢ, setting the initial value of t_{begin} to the value of tₛ_{ₒ}, and initializing an empty set Sₒₚₛ as the set of access behavior sequences; obtaining a subset S_{sub}={sⱼ|tₛ_{ⱼ}∈[t_{begin}, t_{begin}+T], j=1, 2 . . . , n} of the temporal ordered set S_{sorted} constructed by all sets s in the temporal ordered set S_{sorted} in the time range [t_{begin}, t_{begin}+T]; making all uₛ_{ⱼ} of the subset S_{sub} into a set, where uₛ_{ⱼ} represents the value of username in sⱼ, and deduplicating to get a set U={uₖ, k=1, 2, . . . , m}, where m is the number of u after deduplication; traversing the temporal ordered set S_{sub}, and putting aₛ_{ⱼ} of sⱼ with the same uₛ_{ⱼ} in a same array, to obtain a set opsᵢ= [a₁, a₂, . . . , aₚ], i=1, 2 . . . , m, where aₛ_{ⱼ} is the value of eventName in sⱼ; adding the obtained set opsᵢ into the empty set Sₒₚₛ; and updating t_{begin}=t_{begin}+T, and generating the set of access behavior sequences Sₒₚₛ in response to the value of t_{begin} is bigger than tₛ_{ₙ}.

In an embodiment, when executed by the one or more processors, the set of computer program instructions further perform actions of: obtaining an event set A={a₁, a₂, . . . , ag} from the set of access behavior sequences Sₒₚₛ, where A represents all eventName that have occurred in the set of access behavior sequences Sₒₚₛ, and q represents the total number of classes; traversing the access behavior sequences in the set of access behavior sequences Sₒₚₛ, and counting the number of occurrences Cₒₚₛ_{ᵢ}={cᵢ₁, cᵢ₂, . . . , c_{iq}}, i=1, 2 . . . , m of each a corresponding to each access behavior sequence; and calculating the feature vector vᵢ=W·Cₒₚₛ_{ᵢ}, i=1, 2 . . . , m, where vᵢ represents the feature vector of an access behavior sequence opsᵢ, and W represents a weight vector.

In an embodiment, when executed by the one or more processors, the set of computer program instructions further perform actions of: calculating by Cₒₚₛ_{ᵢ} to get that aᵢ occurs in cₐ_{ᵢ} number of the access behavior sequence opsᵢ, and calculating its corresponding weight

$${w}_{i} = ln \frac{m}{{c}_{{a}_{i}} + ε}$$

to obtain the weight vector W={w₁, w₂, . . . , w_{q}}, where ε is the bias.

In an embodiment, the machine learning may be based on an unsupervised learning algorithm.

In addition, according to another embodiment of the present disclosure, a computer program product for detecting abnormal access behavior based on machine learning is disclosed. As an example, the computer program product comprises a non-transitory computer readable storage medium having program instructions embodied therewith, and the program instructions are executable by a processor. When executed, the program instructions cause the processor to perform one or more of the procedures described above, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The processor(s) may be an integrated circuit chip with signal processing capability. The processor may be a general processor, a digital signal processor (DSP), an application specific integrated circuit (ASIC), an off-the-shelf programmable gate array (FPGA) or other programmable logic devices, discrete gate or transistor logic devices, and discrete hardware components, for implementing or executing the methods, steps and logic blocks or the operations disclosed in the embodiments of the present application. The general processor may be a microprocessor or any conventional processor, and it may be X84 architecture or ARM architecture.

The nonvolatile storage medium (media) may be read-only memory (ROM), programmable read-only memory (PROM), erasable programmable read-only memory (EPROM), electrically erasable programmable read-only memory (EEPROM) or flash memory. It should be noted that the memories of the methods described in present application are intended to include, but are not limited to, these and any other suitable types of memories.

Reference to an element in the singular is not intended to mean “one and only one” unless specifically so stated, but rather “one or more.” Similarly, reference to an element in the plural is not intended to mean “more than one” unless specifically so stated or being contradictory with the description elsewhere, but rather “one or more.” Terms such as “if,” “when,” and “while” should be interpreted to mean “under the condition that” rather than implying an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

It should be noted that the flowcharts and block diagrams in the attached drawings illustrate the possible architectures, functions and operations of the methods and apparatuses according to various embodiments of the present application. In this regard, each block in the flowchart or block diagram may represent a module, a program segment, or a part of code, which contains at least one executable instruction for implementing a specified logical function. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or by a combination of dedicated hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of and is not intended to convey an indication of a preferred or ideal embodiment.” “Such as” is not used in a restrictive sense, but for explanatory purposes.

It should be noted that the above-mentioned examples illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfill the functions of several units recited in the claims. Any reference signs in the claims shall not be construed so as to limit their scope.

What is claimed is:

1. A method for detecting abnormal access behavior based on machine learning, comprising:
obtaining log files stored with access records to create a data set based on the log files;
processing the data set as a set of access behavior sequences;
clustering feature vectors of a portion of access behavior sequences in the set of access behavior sequences based on a clustering algorithm in the machine learning and using a centroid of a cluster as a basis for dividing the feature vectors to construct an access behavior recognition model; and
automatically recognizing whether an access behavior is the abnormal access behavior through the access behavior recognition model.

2. The method of claim 1, wherein constructing the access behavior recognition model comprising:
clustering the feature vectors of the portion of access behavior sequences using the clustering algorithm to obtain an initial clustering model containing a plurality of clusters; and
clustering feature vectors of other access behavior sequences in the set of access behavior sequences into a corresponding cluster of the plurality of clusters based on a centroid of each cluster of the plurality of clusters to obtain the access behavior recognition model.

3. The method of claim 2, wherein constructing the access behavior recognition model further comprising:
calculating the similarity between the feature vectors of the portion of access behavior sequences to cluster the feature vectors of the portion of access behavior sequences to obtain the initial clustering model containing the plurality of clusters;
for the each cluster, obtaining the centroid of the each cluster by calculating an average value of feature vectors in the each cluster;
obtaining a centroid corresponding to a minimum value by calculating the minimum value of similarity between the feature vectors of other access behavior sequences and the centroid of the each cluster;
comparing the centroid corresponding to the minimum value with a clustering threshold; and
adjusting the initial clustering model based on a comparison result.

4. The method of claim 3, wherein calculating the similarity between the feature vectors of the portion of access behavior sequences comprising:
calculating the similarity between the feature vectors of the portion of access behavior sequences to cluster the feature vectors of the portion of access behavior sequences by the following formula:
$$Similarity ( {v}_{i} , {v}_{j} ) = 1 - \frac{{v}_{i} \cdot {v}_{j}}{‖ {v}_{i} ‖ \cdot ‖ {v}_{j} ‖}$$
where ∥⋅∥ is a l₂ norm, vᵢ representing the feature vector of the i-th access behavior sequence, vⱼ representing the feature vector of the j-th access behavior sequence, where i,j=1, 2, . . . , m, and m is the total number of access behavior sequences.

5. The method of claim 3, wherein adjusting the initial clustering model based on the comparison result comprising:
in response to the centroid corresponding to the minimum value is greater than or equal to the clustering threshold, increasing the number of clusters by 1; and
in response to the centroid corresponding to the minimum value is smaller than the clustering threshold, adding the corresponding feature vector among the feature vectors of other access behavior sequences into the corresponding cluster, and updating the centroid corresponding to the minimum value.

6. The method of claim 5, wherein updating the centroid corresponding to the minimum value by the following formula:
$${rep}_{min} = {rep}_{min} + \frac{{v}_{i} - {rep}_{min}}{\vert Cluster ( {rep}_{min} ) \vert}$$
wherein repₘᵢₙ represents a centroid corresponding to the minimum value, vᵢ represents a feature vector among the feature vectors of other access behavior sequences, and Cluster(repₘᵢₙ) represents the obtained cluster corresponding to repₘᵢₙ.

7. The method of claim 1, wherein recognizing whether an access behavior is the abnormal access behavior comprising:
for a current time, obtaining an access log file within a time period before and after the current time;
generating a set of access behavior sequences corresponding to the access log file in the time period;
calculating a feature vector for each access behavior sequence in the set of access behavior sequences corresponding to the access log file;
calculating a minimum value of similarity between the feature vector and all centroids of the access behavior recognition model to determine a cluster to which the feature vector belongs and the corresponding centroid;
calculating a distance between the feature vector and the corresponding centroid based on a distance algorithm to obtain a minimum distance value; and
comparing the minimum distance value with a predefined threshold, to recognize whether an access behavior is the abnormal access behavior.

8. The method of claim 7, wherein recognizing whether an access behavior is the abnormal access behavior further comprising:
in response to the minimum distance value is greater than the predefined threshold, the access behavior recognition model recognizes the access behavior corresponding to the feature vector as the abnormal access behavior; and
in response to the minimum distance value is less than or equal to the predefined threshold, the access behavior recognition model recognizes the access behavior corresponding to the feature vector as a normal access behavior.

9. The method of claim 1, further comprising:
in response to the access behavior recognition model recognizes the abnormal access behavior, analyzing a log file corresponding to the abnormal access behavior and performing a risk rating on the abnormal access behavior to alarm based on the risk rating.

10. The method of claim 9, wherein performing a risk rating on the abnormal access behavior to alarm based on the risk rating comprising:
extracting an event and a corresponding resource from the log file corresponding to the abnormal access behavior, wherein the event is divided into a high-level event, a medium-level event, and a low-level event, and the resource is divided into a risk resource and a safe resource;
wherein in response to the extracted event includes the high-level event and the corresponding resource is the risk resource, the abnormal access behavior is defined as a high-risk behavior;
in response to the extracted event includes the high-level event and the corresponding resource is the safe resource, or the extracted event includes the medium-level event and the corresponding resource is the risk resource, the abnormal access behavior is defined as a medium-risk behavior, and
in response to the extracted event includes the medium-level event and the corresponding resource is the safe resource, or the extracted event includes the low-level event, the abnormal access behavior is defined as a low-risk behavior.

11. The method of claim 1, wherein processing the data set as a set of access behavior sequences comprising:
extracting information of specified fields indicating an access behavior of a user from the data set to generate the set of access behavior sequences based on the extracted information.

12. The method of claim 1, wherein the method is applicable to all data centers, including internal data centers and hosted data centers.

13. The method of claim 1, wherein the machine learning is based on an unsupervised learning algorithm.

14. A device, comprising:
one or more processors;
a memory coupled to the one or more processors; and
a set of computer program instructions stored in the memory, which, when executed by the one or more processors, perform actions of:
obtaining log files stored with access records to create a data set based on the log files;
processing the data set as a set of access behavior sequences;
clustering feature vectors of a portion of access behavior sequences in the set of access behavior sequences based on a clustering algorithm in machine learning and using a centroid of a cluster as a basis for dividing the feature vectors to construct an access behavior recognition model; and
automatically recognizing whether an access behavior is the abnormal access behavior through the access behavior recognition model.

15. The device of claim 14, wherein constructing the access behavior recognition model comprising:
clustering the feature vectors of the portion of access behavior sequences using the clustering algorithm to obtain an initial clustering model containing a plurality of clusters; and
clustering feature vectors of other access behavior sequences in the set of access behavior sequences into a corresponding cluster of the plurality of clusters based on a centroid of each cluster of the plurality of clusters to obtain the access behavior recognition model.

16. The device of claim 15, wherein constructing the access behavior recognition model further comprising:
calculating the similarity between the feature vectors of the portion of access behavior sequences to cluster the feature vectors of the portion of access behavior sequences to obtain the initial clustering model containing the plurality of clusters;
for the each cluster, obtaining the centroid of the each cluster by calculating an average value of feature vectors in the each cluster;
obtaining a centroid corresponding to a minimum value by calculating the minimum value of similarity between the feature vectors of other access behavior sequences and the centroid of the each cluster;
comparing the centroid corresponding to the minimum value with a clustering threshold; and
adjusting the initial clustering model based on a comparison result.

17. The device of claim 16, wherein adjusting the initial clustering model based on the comparison result comprising:
in response to the centroid corresponding to the minimum value is greater than or equal to the clustering threshold, increasing the number of clusters by 1; and
in response to the centroid corresponding to the minimum value is smaller than the clustering threshold, adding the corresponding feature vector among the feature vectors of other access behavior sequences into the corresponding cluster, and updating the centroid corresponding to the minimum value.

18. The device of claim 14, wherein recognizing whether an access behavior is the abnormal access behavior comprising:
for a current time, obtaining an access log file within a time period before and after the current time;
generating a set of access behavior sequences corresponding to the access log file in the time period;
calculating a feature vector for each access behavior sequence in the set of access behavior sequences corresponding to the access log file;
calculating a minimum value of similarity between the feature vector and all centroids of the access behavior recognition model to determine a cluster to which the feature vector belongs and the corresponding centroid;
calculating a distance between the feature vector and the corresponding centroid based on a distance algorithm to obtain a minimum distance value; and
comparing the minimum distance value with a predefined threshold, to recognize whether an access behavior is the abnormal access behavior.

19. The method of claim 18, wherein recognizing whether an access behavior is the abnormal access behavior further comprising:
in response to the minimum distance value is greater than the predefined threshold, the access behavior recognition model recognizes the access behavior corresponding to the feature vector as the abnormal access behavior; and
in response to the minimum distance value is less than or equal to the predefined threshold, the access behavior recognition model recognizes the access behavior corresponding to the feature vector as a normal access behavior.

20. A computer program product comprising a non-transitory computer readable storage medium having program instructions embodied therewith, the program instructions executable by one or more processor to cause the one or more processor to:
obtain log files stored with access records to create a data set based on the log files;
process the data set as a set of access behavior sequences;
cluster feature vectors of a portion of access behavior sequences in the set of access behavior sequences based on a clustering algorithm in machine learning and use a centroid of a cluster as a basis for dividing the feature vectors to construct an access behavior recognition model; and
automatically recognize whether an access behavior is the abnormal access behavior through the access behavior recognition model.
